(19) United States
(12) Patent Application Publication
(10) Pub. No.: US 2007/0089271 A1
(43) Pub. Date: Apr. 26, 2007

(54) Hinge unit and an image forming apparatus having the same

(75) Inventors: Kyoo-sang Jo, Seoul (KR); Won-taek Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/483,647

(22) Filed: Jul. 11, 2006

(30) Foreign Application Priority Data
Oct. 20, 2005 (KR) 2005-99152

(51) Int. Cl. E05F 1/08

(52) U.S. Cl. 16/286

(57) ABSTRACT

A hinge unit applies resilience differently according to the angle at which the hinge unit is opened, and an image forming apparatus has a cover attached by the hinge unit. The hinge unit includes a lower frame connected to a scan unit of a main body of an apparatus; an upper frame engaged with the lower frame through a hinge shaft and connected to a cover; and first and second resilient members serially arranged within the upper frame. When the cover pivots toward the scan unit at less than a predetermined angle, the hinge unit provides relatively minor resistance, whereas when the cover pivots toward the scan unit at the predetermined angle or greater, the hinge unit provides relatively greater resistance, thereby appropriately coping with the moment by weight of the cover. As a result, the improved hinge unit may enable a user to open and close the cover more comfortably.

### CROSS-REFERENCE TO RELATED APPLICATIONS

This application claims the benefit of Korean Application No. 2005-99152, filed Oct. 20, 2005, in the Korean Intellectual Property Office, the disclosure of which is incorporated herein by reference.

### BACKGROUND OF THE INVENTION

1. Field of the Invention

Aspects of the present invention relate to a hinge unit and an image forming apparatus having the same. More particularly, aspects of the present invention relate to a hinge unit capable of smoothly operating by applying a resilience that varies according to an open angle of a hinge unit, and an image forming apparatus having a cover connected to a main body of the image forming apparatus by the hinge unit.

2. Description of the Related Art

Generally, image forming apparatuses that include a scanning function, such as, for example, copiers, scanners, and multifunction apparatuses, scan a document and store an image read from the document as data or print out the image on a print medium such as paper.

FIG. 1 shows a conventional multifunction apparatus as an example of an image forming apparatus. Referring to FIG. 1, the multifunction apparatus comprises a scan unit 2 formed at a main body 1 thereof to read images from a document placed on the scan unit 2, a cover 3 covering the document, and a hinge unit 10 connecting the scan unit 2 and the cover 3. An automatic document feeder (ADF) 4 may be further mounted to the cover 3 to automatically supply a plurality of sheets of the document to the scan unit 2. In a high-speed multifunction apparatus or copier, a duplex ADF may be mounted to the cover 3. However, a cover 3 having a duplex ADF is typically so heavy that a user cannot conveniently lift and lower the cover 3.

In a general image forming apparatus, the cover is typically able to pivot by approximately 80°. The moment generated by pivoting the cover does not regularly increase according to the open angle of the cover. As the cover is becomes more and more closed, in other words, as the open angle of the cover with respect to a scan unit becomes close to 0°, the moment and resilience for balancing increase. Therefore, it is hard to maintain the moment equilibrium according to the open angle with a typical hinge unit containing only one spring. Although a single spring is generally mounted to the hinge unit, a pair of springs may be mounted in parallel when greater force is required. However, when using one or two parallel springs, the design freedom of the apparatus is poor. An over-spec spring needs to be employed in order to apply spring forces differently according to various opening angles. However, an over-spec spring does not offer the user a good feeling in opening and closing the cover. In order to provide a favorable opening and closing operation of the cover requiring only a minor force when performing scanning or copying work, configuration of the spring of the hinge unit connecting the cover with the scan unit of the main body becomes an essential issue.

FIG. 2 is a sectional view showing the structure of a hinge unit 10 mounted in the conventional image forming apparatus, as disclosed in Japanese Patent Publication No. 2003-129739. In the hinge unit 10, two springs 11 and 12 are serially connected.

Referring to FIG. 2, the hinge unit 10 comprises a cam base 30 connected to a cover 3, a plunger 21 received in a hinge housing 20 to move back and forth and having a slanted face 22, first and second springs 11 and 12 received in the hinge housing 20 and pushing the plunger 21, and first and second cams 31 and 32 pivoting in association with the cam base 30 and contacting the slanted face 22. In the above-structured hinge unit 10, a resistant force as a reaction by the first cam 31 is applied to the slanted face 22 of the plunger 21 in the direction of a common normal of the point of contact with the first cam 31. Therefore, the resistant force operates as a moment inclining the plunger 21 to the rotational direction (illustrated by an arrow) so that the plunger 21 may swerve from the first cam 31, thereby increasing the torque in the open direction around a hinge shaft P. Accordingly, enough force can be obtained for popping up the cover 3, and also for preventing the cam base 30 and the plunger 21 from deforming. However, the hinge unit 10 may become worn along the first and the second cams 31 and 32 and the slanted face 22 of the plunger 21. The user still has to apply a great force to open and close the cover 3, especially a heavy cover, and accordingly, the cover 3 cannot be smoothly pivoted.

### SUMMARY OF THE INVENTION

An aspect of the present invention is to solve the above and/or other problems and disadvantages and to provide at least the advantages described below. Accordingly, an aspect of the present invention is to provide a hinge unit enabling a user to smoothly open and close a cover of an image forming apparatus with only a minor force, by applying resilience of different degrees according to an open angle of the cover.

Another aspect of the present invention is to provide an image forming apparatus having the above-mentioned hinge unit.

According to an aspect of the present invention, there is provided a hinge unit comprising a lower frame connected to a scan unit of a main body of an image forming apparatus; an upper frame engaged with the lower frame through a hinge shaft and connected to a cover of the image forming apparatus; and first and second resilient members serially arranged within the upper frame, wherein, when the cover pivots toward the scan unit, the first resilient member displaces first and then the second resilient member displaces.

According to an aspect of the present invention, the upper frame comprises a fixed holder mounted at one end thereof to receive the first resilient member; a first movable holder mounted to be opposed to the fixed holder, receiving the second resilient member, and moving along a length direction of the upper frame; and a second movable holder disposed between the first and the second resilient members to move along the length direction of the upper frame.

According to an aspect of the present invention, the upper frame comprises a guide rail that guides sliding movement of the first and the second movable holders along the length direction of the upper frame.

According to an aspect of the present invention, the upper frame further comprises a fixed member that prevents the fixed holder from being pushed outward.

According to an aspect of the present invention, the lower frame comprises a link fixed in front of the hinge shaft to contact with the first movable holder.

According to an aspect of the present invention, at least one of the fixed holder and the second movable holder comprises sidewalls on surfaces thereof opposite to each other. The fixed holder may have a sidewall that extends downward, that is, in the direction of the second movable holder. The second movable holder may have a sidewall that extends upward and/or downward, that is, in the direction of the fixed holder and/or in the direction of the first movable member. The total height of the sidewalls of the fixed holder and sidewalls of the second movable holder extending toward the fixed holder is equal to or greater than length of the first resilient member when the first member is completely compressed. In addition, the respective holders may include mounting parts for seating the first and second resilient members therein.

Preferably, but not necessarily, the first and the second resilient members are springs, and the spring constant K1 of the first resilient member is smaller than the spring constant K2 of the second resilient member.

An image forming apparatus according to another aspect of the present invention may comprise a main body including a scan unit, and a cover connected with a scan unit of the main body by the above-described hinge unit.

According to another aspect of the present invention, a hinge unit of an image forming apparatus having a cover and a main body with a scan unit, comprises a lower frame connected to a scan unit of a main body of an image forming apparatus; an upper frame engaged with the lower frame through a hinge shaft and connected to a cover of the image forming apparatus; and a plurality of resilient members serially arranged within the upper frame, wherein an overall resilience of the hinge unit is controlled by selecting a resilience of individual resilient members of the plurality of serially arranged resilient members.

According to another aspect of the present invention, an apparatus has a main body and a cover, wherein the cover is connected with the main body through a hinge unit, wherein the hinge unit comprises, a lower frame connected to the main body; an upper frame engaged with the lower frame through a hinge shaft and connected to the cover, and first and second resilient members serially arranged within the upper frame, wherein the first resilient member displaces before the second resilient member when the cover pivots toward the scan unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exterior view of a conventional multifunction apparatus;

FIG. 2 is a sectional view showing the structure of a conventional hinge unit;

FIG. 3 is a perspective view showing the hinge unit as assembled;

FIG. 4 is an exploded perspective view of FIG. 3;

FIG. 5 is a longitudinal-sectional view of FIG. 3;

FIG. 6 is a front view showing the detailed structure of resilient members of FIG. 3;

FIG. 7 is a view showing the structure of a hinge unit according to another embodiment of the present invention;

FIGS. 8A through 8D are views showing the operation of the hinge unit of FIG. 7; and

FIG. 9 is a graph illustrating relationships between loads and open angles of the cover with respect to the hinge unit.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Well-known functions or constructions are not described in detail since they would obscure the invention in unnecessary detail.

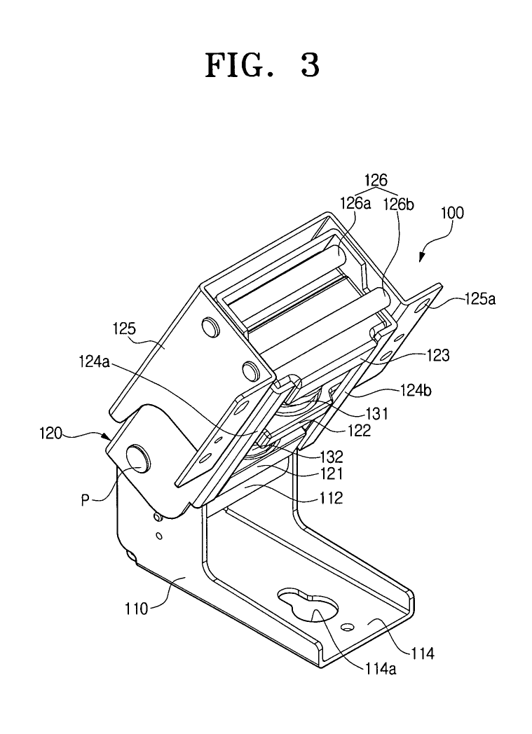

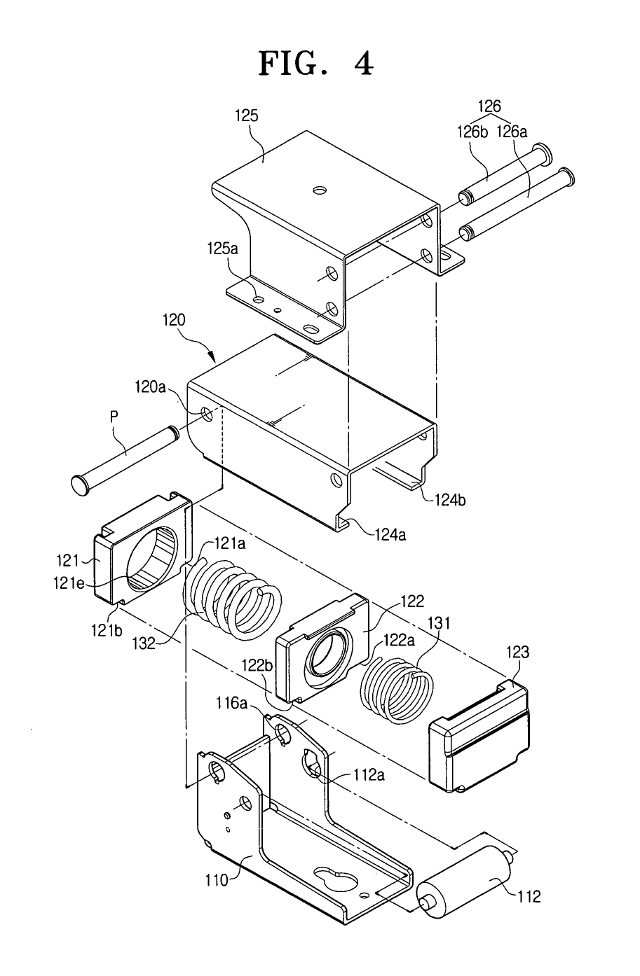

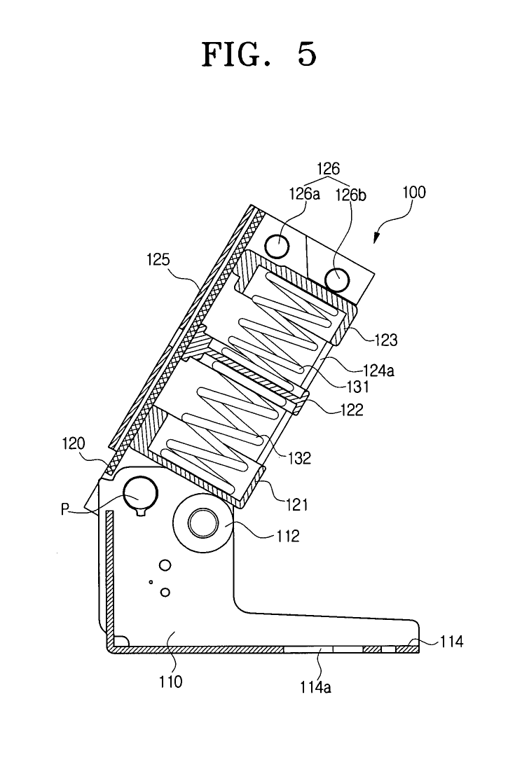

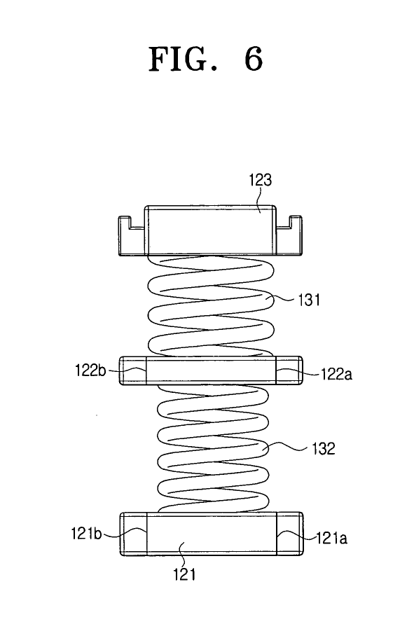

FIGS. 3 through 6 are an assembled view, an exploded perspective view, a longitudinal-sectional view, and a front view, respectively, for showing a hinge unit according to an embodiment of the present invention. Referring to the drawings, the hinge unit 100 comprises a lower frame 110, and an upper frame 120 connected to the lower frame 110 through a hinge shaft P.

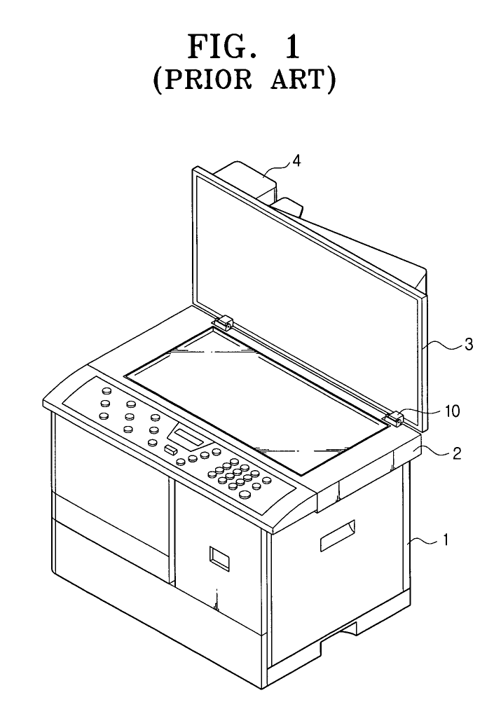

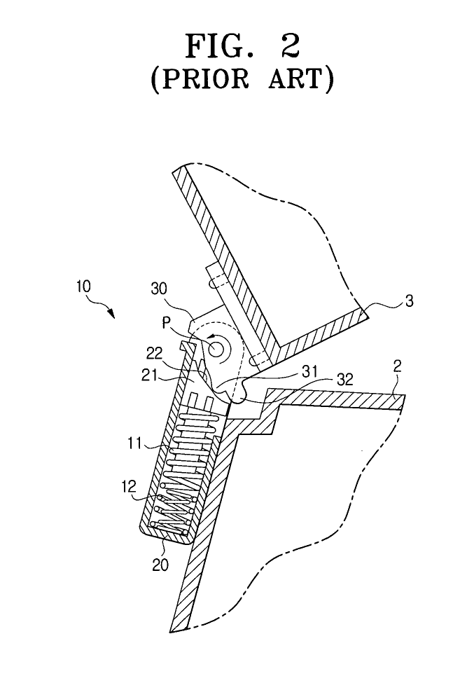

The hinge unit may connect a cover of an image forming device with the scan unit of the main body of an image forming device. Aspects of the image forming device may be the same as those shown in FIG. 1, with respect to the main body 1, the scanning unit 2, the cover 3 and optional automatic document feeder 4, except that the hinge unit according to embodiments of the present invention described herein replaces the conventional hinge unit 10 shown in FIGS. 1 and 2. The lower frame 110 of the hinge 100 is connected to a scan unit 2 mounted to a main body 1 (FIG. 1) of an image forming apparatus. The lower frame 110 may comprise a fastening hole 114a on a bottom surface 114 thereof, to be connected with the scan unit 2 by a fastening member (not shown). The hinge shaft P is mounted to the lower frame 110 through a shaft hole formed in front of the hinge shaft P. In other words, the link 112 is placed so that it is offset from the hinge shaft P within the angle of rotation of the hinge 100. The hinge shaft P and the link 112 may be formed as cylindrical bars. The link 112, contacts and engages with a first movable holder 121 of the upper frame 120.

The upper frame 120 is connected to the cover 3 (FIG. 1) of the image forming apparatus and coupled with the lower frame 110 by the hinge shaft P passing through a connection hole 120a formed at one side thereof. The upper frame 120 may be fixedly mounted to the cover 3 through a connection member 125.

The upper frame 120 comprises first and second resilient members 131 and 132 that are serially arranged. Although the number of the resilient member is not limited, it is preferable to serially arrange two resilient members 131 and 132.

The upper frame 120 has a fixed holder 123 formed at an upper side and a first movable holder 121 formed at a lower side opposite to the fixed holder 123. As used herein, the term “lower side” of the upper frame 120 refers to the portion of the frame that is adjacent to the hinge shaft P and the term “upper side” of the upper frame 120 refers to the opposite portion of the upper frame 120, that is, the portion that is farthest away from the hinge shaft P. The fixed holder 123 supports the first resilient member 131 so that the first resilient member 131 is not pushed out of the upper frame 120. In addition, fixed members 126a and 126b may be provided to the upper frame 120 or the connection member 125 in order to prevent the fixed holder 123 from being pushed out of the upper frame 120. Alternatively, the fixed holder 123 may be attached directly to the upper frame 120 or to the connection member 125.

The first and the second resilient members 131 and 132 are serially arranged between the fixed holder 123 and the first movable holder 121. Preferably, but not necessarily, the first movable holder 121 has a mounting part 121e constructed by sidewalls of a bottom portion thereof to receive therein an end of the second resilient member 132. Therefore, the second resilient member 132 can be stably received in the first movable holder 121 by the mounting part 121e of the first movable holder 121. The fixed holder 123 may also have such a mounting part.

In addition, a second movable holder 122 is formed between the first and the second resilient members 131 and 132.

The upper frame 120 may include guide rails 124a and 124b at both flanks along a length direction thereof that allow the first and the second movable holders 121 and 122 to slide in the length direction. The first and the second movable holders 121 and 122 comprise first guide grooves 121a and 121b and second guide grooves 122a and 122b, respectively, that allow the first and the second movable holders 121 and 122 to smoothly slide along the guide rails 124a and 124b.

In the hinge unit 100 of this embodiment, springs are employed for the first and the second resilient members 131 and 132. According to this embodiment, it is preferred that a spring constant K1 of the first resilient member 131 is less than a spring constant K2 of the second resilient member 132 so that the first resilient member 131 operates first and the second resilient member 132 operates next.

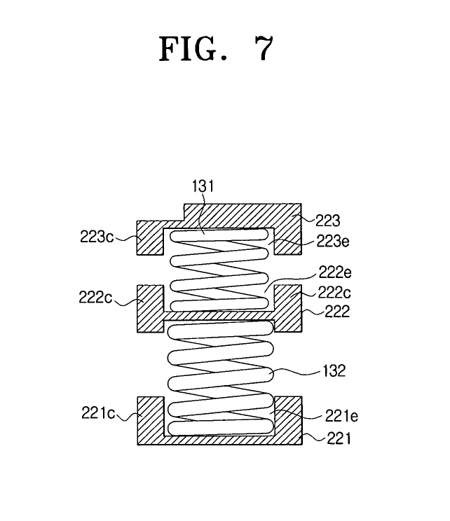

To ensure the orderly operation of the first and the second resilient members 131 and 132, and to prevent the resilient members from popping out of the upper frame 120, the fixed holder, and first and second movable holders may further include sidewalls. Holders having sidewalls are shown as the first movable holder 221, second movable holder, 222 and fixed holder 223 in the embodiment shown in FIG. 7. In the embodiment shown in FIG. 7, the other structures are the same as those of the hinge unit 100 of FIG. 3 except that the holders 221 to 223 include sidewalls, respectively. For convenient explanation, only the holders 221 to 223 and the resilient members 131 and 132 are illustrated in FIG. 7.

In the hinge unit 200 according to the embodiment of FIG. 7, one or both of the second movable holder 221 and the fixed holder 223 may comprise sidewalls on surfaces thereof opposite to each other. As shown in FIG. 7, sidewalls 222c and 223c may be formed on circumferences or perimeters of both the second movable holder 222 and the fixed holder 223 to be opposed to each other. Preferably, a total height of the fixed holder sidewall 223c and the movable holder sidewall 222c is equal to or greater than a height of the first resilient member when the first resilient member 131 is completely compressed, so that the operation of the first resilient member 131 is followed by that of the second resilient member 132. More particularly, when the first resilient member 131 is compressed, the movable holder sidewall 222c and the fixed holder sidewall 223c come into contact with each other, thereby restraining the operation of the first resilient member 131 and promoting the operation of the second resilient member 132.

Sidewalls 221c to 223c of the respective holders 221 to 223 comprise mounting parts 221e to 223e, respectively, to stably receive the resilient members 131 and 132. The second movable holder 222 may further comprise another sidewall 222'c formed on a lower part thereof.

The above-structured hinge unit is applicable to various devices mounting a cover, such as the image forming apparatus having the cover 3 hingedly connected to the main body 1 comprising the scan unit 2 and to the scan unit 2 of the main body 1. Especially, the hinge unit according to embodiments of the present invention may be used for an image forming apparatus having a relatively heavy cover mounting an automatic document feeder (ADF) 4 (FIG. 1) thereon. The hinge unit may be used with other apparatuses having a heavy cover, such as, for example, a chest freezer.

Hereinbelow, the operations and effects of the hinge unit according to embodiments of the present invention will be described with reference to the accompanying drawings.

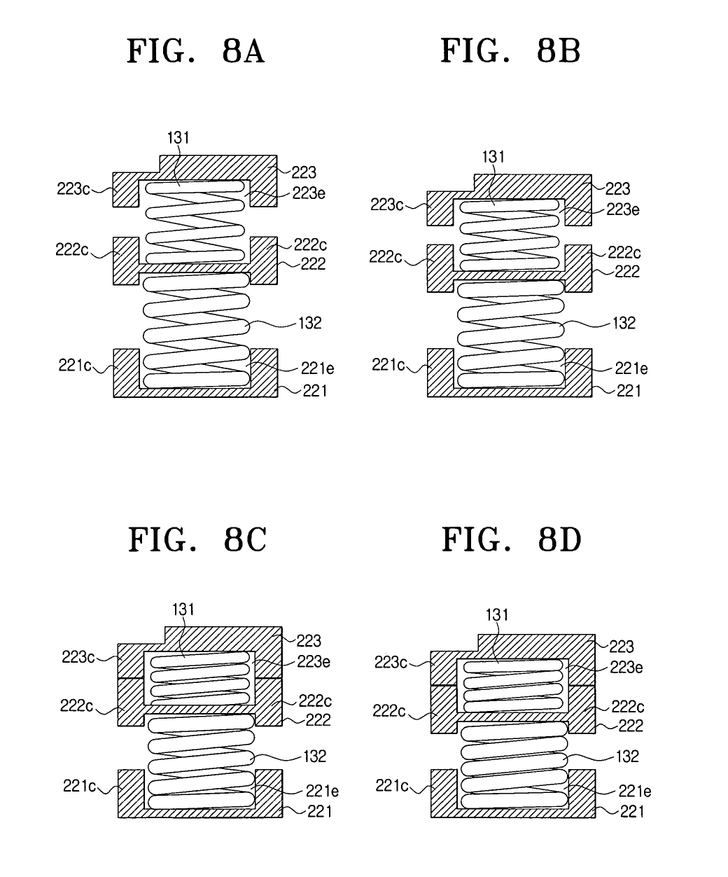

FIGS. 8A through 8D show the operation of the hinge unit applied to the image forming apparatus according to the embodiment of FIG. 7. For convenient explanation, only the holders 221 to 223 and the two springs 131 and 132 are illustrated. It is to be understood that the upper frame 120 of the hinge unit 200 is fixed to the cover of the image forming apparatus, and the lower frame 110 is fixed to the scan unit of the main body and that the remaining features of the hinge unit 200 may be as shown, for example, in FIGS. 3-5. Moreover, it is to be understood that aspects of the image forming device may be the same as those shown in FIG. 1, with respect to the main body 1 and the cover 3, except that the hinge unit according to FIGS. 3-8 replaces the conventional hinge unit 10 shown in FIGS. 1 and 2.

Generally, the cover 3 of the image forming apparatus is opened and closed pivoting by approximately 80°. The moment generated by pivot of the cover 3 is not regularly increased according to an open angle of the cover 3. As the cover 3 is being closed, in other words, as the open angle of the cover 3 with respect to a scan unit is becoming 0°, the moment and resilience for balancing increase. In the hinge unit of FIG. 8, the two springs 131 and 132 are arranged in a serial manner so as to balance the moment according to the open angle of the cover 3.

Presuming that ‘K1’ denotes a spring constant of the first spring 131 and ‘K2’ denotes a spring constant of the second spring 132, the springs wherein K1 is smaller than K2 are used so that the first spring 131 is displaced ahead of the second spring.

In FIG. 8A, the state is shown in which the cover 3 is completely open so that no force is applied to the movable holders 221 and 222. When the cover 3 begins to be closed, the second movable holder 222 and the fixed holder 223 are pushed in an angular direction by the rotation of the upper frame 120 about the hinge shaft P. The cover 3 begins to generate a large moment with respect to the hinge shaft P due to its own weight. Correspondingly, resilience is generated by the link 112 (FIG. 3). The link 112 restrains the movement of the first movable holder 221 in the angular direction, thereby hindering closing of the cover and pushes the first movable holder 221 in the direction of the fixed member 223. Since the spring constant K1 of the first spring 131 is smaller than the spring constant K2 of the second spring 132, the second movable holder is also pushed in the direction of the fixed member 223. The second spring 132 remains uncompressed while the first spring begins to be compressed, as shown in FIG. 8B. Since the springs 131 and 132 are serially arranged, the total spring constant in the state of FIG. 8B can be expressed as (Kₜₒₜ)=(K1×K2)/(K1+K2).

When the cover 3 is closed by more than a predetermined angle, the first spring 131 becomes compressed completely, and the fixed holder sidewall 223c and the movable holder sidewall 222c are brought into contact with each other, as shown in FIGS. 8C and 8D. As a result, the first spring 131 cannot compress any more and only the second spring 132 can generate resilience. The total spring constant (Kₜₒₜ) in the state of FIG. 8D is equal to K1.

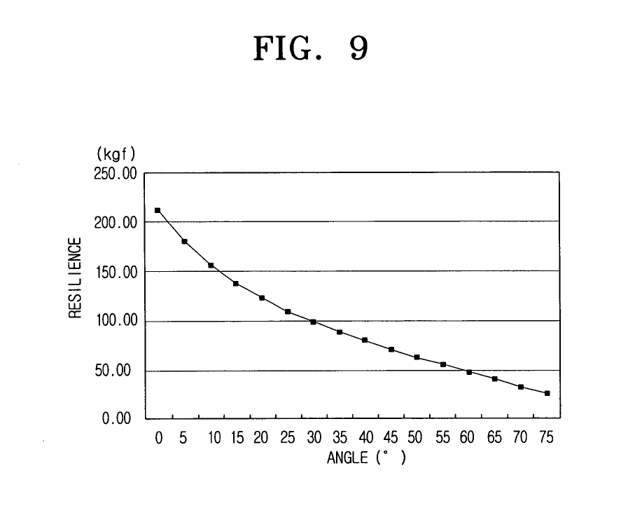

As described above, in the operation of the hinge unit according to aspects of the present invention, the first spring 131 is operated when the open angle of the cover is more than a predetermined angle and then the second spring 132 is operated when the open angle is less than the predetermined angle. Accordingly, the moment caused by the weight of the cover 3 can be properly offset. The resilience of the hinge unit is illustrated in FIG. 9 according to the open angle of the cover 3.

FIG. 9 is a graph for showing the relationships between loads and the open angles of the cover with respect to the hinge unit wherein the two springs are serially arranged. As shown in FIG. 9, when a pivoting angle of the cover is relatively large, for example, at the beginning of closing the cover, a minor force needs to be applied to the cover. However, when the pivoting angle of the cover is relatively small, for example, when the cover is almost closed, a greater force should be applied to the cover.

Therefore, according to embodiments of the present invention, since the spring constants of the resilient members of the hinge unit are properly applied, the cover can be prevented from closing spontaneously or from slamming down too hard when it is closed. Also, the user can comfortably open and close the cover during scanning and copying of works.

As can be appreciated from the hinge unit according to embodiments of the present invention, extent of resilience of the resilient members can be controlled according to the open angle of the cover by serially connecting a plurality of the resilient members, thereby properly offsetting the moment by the weight of the cover. In addition, the feeling to the user when opening and closing the cover is improved.

Although a few embodiments of the present invention have been shown and described, it would be appreciated by those skilled in the art that changes may be made in this embodiment without departing from the principles and spirit of the invention, the scope of which is defined in the claims and their equivalents. For example, a plurality of other resilient members may be applied instead of the first and the second resilient members between the fixed holder and the first movable holder. Furthermore, more movable holders may be added in order to securely mount the plurality of resilient members. Therefore, technical protection range of the invention should be defined by the appended claims.

What is claimed is:

1. A hinge unit of an image forming apparatus having a cover and a main body with a scan unit, comprising:
a lower frame connected to the scan unit of the main body of the image forming apparatus;
an upper frame engaged with the lower frame through a hinge shaft and connected to the cover of the image forming apparatus; and
first and second resilient members serially arranged within the upper frame,
wherein, when the cover pivots toward the scan unit, the first resilient member displaces first and then the second resilient member displaces.

2. The hinge unit of claim 1, wherein the upper frame comprises:
a fixed holder mounted at one end thereof to receive the first resilient member;
a first movable holder mounted to be opposed to the fixed holder, receiving the second resilient member, and moving along a length direction of the upper frame; and
a second movable holder disposed between the first and the second resilient members to move along the length direction of the upper frame.

3. The hinge unit of claim 2, wherein the upper frame comprises a guide rail that guides a sliding movement of the first and the second movable holders along the length direction of the upper frame.

4. The hinge unit of claim 2, wherein the upper frame further comprises a fixed member that prevents the fixed holder from being pushed outward.

5. The hinge unit of claim 2, wherein the lower frame comprises a link fixed in front of the hinge shaft within an angle of rotation of the upper frame to contact with the first movable holder.

6. The hinge unit of claim 2, wherein at least one of the fixed holder and the second movable holder comprises a sidewall on at least one surface thereof.

7. The hinge unit of claim 6, wherein the fixed holder comprises sidewalls that extend in a direction of the second movable holder.

8. The hinge unit of claim 6, wherein the second movable holder comprises sidewalls that extend in a direction of the fixed holder and/or in a direction of the first movable holder.

9. The hinge unit of claim 6, wherein the fixed holder comprises sidewalls that extend in a direction of the second movable holder, wherein the second movable holder comprises sidewalls that extend in a direction of the fixed holder and wherein a total height of the sidewalls extending from the fixed holder in the direction of the second movable holder and sidewalls extending from the second movable holder in the direction of the fixed holder is equal to or greater than length of the first resilient member when the first resilient member is completely compressed.

10. The hinge unit of claim 1, wherein the first and the second resilient members springs, and wherein a spring constant K1 of the first resilient member is smaller than a spring constant K2 of the second resilient member.

11. A hinge unit comprising:
a lower frame having a link;
an upper frame engaged with the lower frame through a hinge shaft;
a fixed holder fixed at one end of the upper frame;
a first movable holder mounted within the upper frame to be opposed to the fixed holder and contacted with the link;
first and second resilient members serially arranged between the fixed holder and the first movable holder; and
a second movable holder disposed between the first and the second resilient members to slide along a guide member that guides movement of the first movable holder.

12. The hinge unit of claim 11, wherein the first resilient member biases the second movable holder in a direction of the first movable holder and the second resilient member biases the first movable holder in a direction of the link.

13. The hinge unit of claim 11, wherein the upper frame further comprises a fixed member that prevents the fixed holder from being pushed outward.

14. The hinge unit of claim 11, wherein at least one of the fixed holder and the second movable holder comprises a sidewall on at least one surface thereof.

15. The hinge unit of claim 14, wherein the fixed holder comprises sidewalls that extend in a direction of the second movable holder.

16. The hinge unit of claim 14, wherein the second movable holder comprises sidewalls that extend in a direction of the fixed holder and/or in a direction of the first movable holder.

17. The hinge unit of claim 14, wherein the fixed holder comprises sidewalls that extend in a direction of the second movable holder, wherein the second movable holder comprises sidewalls that extend in a direction of the fixed holder and wherein a total of a height of the sidewalls extending from the fixed holder in the direction of the second movable holder and a height of the sidewalls extending from the second movable holder in the direction of the fixed holder is equal to or greater than length of the first resilient member when the resilient member is completely compressed.

18. The hinge unit of claim 11, wherein the first and the second resilient members are springs, and a spring constant K1 of the first resilient member is smaller than a spring constant K2 of the second resilient member.

19. The hinge unit of claim 11, wherein, when the upper frame pivots toward the lower frame, the first resilient member displaces first and then the second resilient member displaces.

20. The hinge unit of claim 11, a plurality of resilient members having different spring constants and a plurality of movable holders for receiving the plurality of resilient members are additionally mounted between the fixed holder and the first movable holder.

21. An image forming apparatus comprising:
a main body having a scan unit; and
a cover connected with the scan unit of the main body through a hinge unit,
wherein the hinge unit comprises,
a lower frame connected to the scan unit;
an upper frame engaged with the lower frame through a hinge shaft and connected to the cover; and
first and second resilient members serially arranged within the upper frame,
wherein the first resilient member displaces ahead of the second resilient member when the cover pivots toward the scan unit.

22. The image forming apparatus of claim 20, wherein the first and the second resilient members springs, and spring constant K1 of the first resilient member is smaller than spring constant K2 of the second resilient member.

23. The image forming apparatus of claim 21, wherein when the cover pivots toward the scan unit, the first spring compresses until the cover reaches a predetermined angle with the scan unit and then the second spring compresses.

24. A hinge unit of an image forming apparatus having a cover and a main body with a scan unit, comprising:
a lower frame connected to the scan unit of the main body of the image forming apparatus;
an upper frame engaged with the lower frame through a hinge shaft and connected to the cover of the image forming apparatus; and
a plurality of resilient members serially arranged within the upper frame,
wherein an overall resilience of the hinge unit is controlled by selecting a resilience of individual resilient members of the plurality of serially arranged resilient members.

25. An apparatus having a main body and a cover, wherein the cover is connected with the main body through a hinge unit,
wherein the hinge unit comprises,
a lower frame connected to the main body;
an upper frame engaged with the lower frame through a hinge shaft and connected to the cover, and
first and second resilient members serially arranged within the upper frame,
wherein the first resilient member displaces before the second resilient member when the cover pivots toward the scan unit.
